(19) United States
(12) Patent Application Publication
(10) Pub. No.: US 2024/0421428 A1
(43) Pub. Date: Dec. 19, 2024

(54) ELECTROCHEMICAL APPARATUS

(71) Applicant: ZHUHAI COSMX BATTERY CO., LTD., Zhuhai (CN)

(72) Inventors: Wei ZHAO, Zhuhai (CN); Suli LI, Zhuhai (CN)

(73) Assignee: ZHUHAI COSMX BATTERY CO., LTD., Zhuhai (CN)

(21) Appl. No.: 18/817,638

(22) Filed: Aug. 28, 2024

Related U.S. Application Data
(63) Continuation of application No. PCT/CN2023/088991, filed on Apr. 18, 2023.

(30) Foreign Application Priority Data
May 5, 2022 (CN) 202210482319.7

(51) Int. Cl. H01M 50/431; H01M 4/02; H01M 4/62; H01M 10/0525; H01M 10/0567; H01M 10/0569; H01M 50/46; H01M 50/497

(52) U.S. Cl. CPC H01M 50/431; H01M 4/623; H01M 10/0525; H01M 10/0567; H01M 10/0569; H01M 50/461; H01M 50/497; H01M 2004/027; H01M 2004/028

(57) ABSTRACT

Disclosed is an electrochemical apparatus. The present disclosure relates to the field of electrochemical energy storage technologies. In the present disclosure, a positive electrode electrolyte solution and a negative electrode electrolyte solution are separated by a solid electrolyte membrane. A high content of a nitrile compound is added to the positive electrode electrolyte solution. A high content of an ether compound is added to the negative electrode electrolyte solution. The nitrile compound may effectively improve stability of a positive electrode interface. The ether compound may effectively improve stability of a negative electrode interface. In this way, a cycle life of an electrochemical apparatus is improved, and in particular, a cycle life of an electrochemical apparatus including metal lithium in a negative electrode is improved.

### CROSS-REFERENCE TO RELATED APPLICATIONS

The present disclosure is a continuation of International Application No. PCT/CN2023/088991, filed on Apr. 18, 2023, which claims priority to Chinese Patent Application No. 202210482319.7, filed on May 5, 2022. Both of the aforementioned applications are hereby incorporated by reference in their entireties.

### TECHNICAL FIELD

The present disclosure relates to the field of electrochemical energy storage technologies, and specifically, to an electrochemical apparatus.

### BACKGROUND

As one type of electrochemical apparatus, lithium-ion batteries are widely used secondary batteries. An electrolyte solution of the lithium-ion battery has an important impact on performance of the battery. However, components of the electrolyte solution are complex. Some components are incompatible with a negative electrode of the lithium-ion battery, and some components are incompatible with a positive electrode of the lithium-ion battery. This greatly shortens a cycle life of the battery.

### SUMMARY

To resolve a problem that an electrolyte solution is incompatible with an electrode of an electrochemical apparatus, the present disclosure provides an electrochemical apparatus. In the electrochemical apparatus, a positive electrode electrolyte solution and a negative electrode electrolyte solution are separated by a solid electrolyte membrane, so that an electrolyte solution in contact with a positive electrode plate and an electrolyte solution in contact with a negative electrode plate are different. In this way, a problem that some components in the electrolyte solution are incompatible with a positive electrode plate or a negative electrode plate is resolved. The electrochemical apparatus designed in this way has a significantly improved cycle life.

An objective of the present disclosure is implemented by using the following technical solutions.

An electrochemical apparatus includes a positive electrode plate, a negative electrode plate, a solid electrolyte membrane, a positive electrode electrolyte solution, a negative electrode electrolyte solution, and a packaging case.

The positive electrode plate and the negative electrode plate are located on two sides of the solid electrolyte membrane. The positive electrode electrolyte solution is located on one side of the positive electrode plate. The negative electrode electrolyte solution is located on one side of the negative electrode plate. The positive electrode electrolyte solution and the negative electrode electrolyte solution are separated by the solid electrolyte membrane.

Beneficial effects of the present disclosure are as follows.

In the present disclosure, a positive electrode electrolyte solution and a negative electrode electrolyte solution are separated by a solid electrolyte membrane. A high content of a nitrile compound is added to the positive electrode electrolyte solution. A high content of an ether compound is added to the negative electrode electrolyte solution. The nitrile compound can effectively improve stability of a positive electrode interface. The ether compound can effectively improve stability of a negative electrode interface. The nitrile compound does not permeate to be in contact with a negative electrode and to cause an adverse side reaction with the negative electrode. The ether compound does not permeate to be in contact with a positive electrode and to cause an adverse oxidation reaction with the positive electrode. A cycle life of an electrochemical apparatus designed in this way is significantly improved, and in particular, a cycle life of an electrochemical apparatus including metal lithium in a negative electrode is improved.

### BRIEF DESCRIPTION OF THE DRAWINGS

FIG. 1 is a cross-sectional view (a cross-sectional view in a vertical lamination direction) of a structure of a lithium-ion battery according to the present disclosure.

FIG. 2a is a schematic diagram of a positive electrode plate (a top view in a lamination direction).

FIG. 2b is a schematic diagram of a solid electrolyte membrane (a top view in a lamination direction).

FIG. 2c is a schematic diagram of a negative electrode plate (a top view in a lamination direction).

### DETAILED DESCRIPTION OF THE EMBODIMENTS

Generally, components of an electrolyte solution in an electrochemical apparatus are complex. Some components are incompatible with a negative electrode of the electrochemical apparatus, and some components are incompatible with a positive electrode of the electrochemical apparatus, which limits application of the electrochemical apparatus. A nitrile compound can effectively stabilize a transition metal element, thereby improving stability of a positive electrode interface. However, the nitrile compound has an adverse side reaction with the negative electrode. Therefore, to improve a cycle life, an added amount of the nitrile compound in the electrochemical apparatus is strictly controlled within 5%. An ether compound can effectively improve stability of a negative electrode interface. However, the ether compound has an adverse side reaction with the high-voltage positive electrode. Therefore, to improve the cycle life, an added amount of the ether compound in the electrochemical apparatus is strictly controlled within 4%, and even no ether compound is added in the actual application.

It is surprisingly found by the inventor of the present disclosure that the cycle life of the electrochemical apparatus can be effectively improved if a positive electrode electrolyte solution and a negative electrode electrolyte solution are separated by a solid electrolyte membrane, a high content of the nitrile compound is added to the positive electrode electrolyte solution, and a high content of the ether compound is added to the negative electrode electrolyte solution.

### <Electrochemical Apparatus>

The present disclosure provides an electrochemical apparatus. The electrochemical apparatus includes a positive electrode plate, a negative electrode plate, a solid electrolyte membrane, a positive electrode electrolyte solution, a negative electrode electrolyte solution, and a packaging case.

The positive electrode plate and the negative electrode plate are located on two sides of the solid electrolyte membrane. The positive electrode electrolyte solution is located on one side of the positive electrode plate. The negative electrode electrolyte solution is located on one side of the negative electrode plate. The positive electrode electrolyte solution and the negative electrode electrolyte solution are separated by the solid electrolyte membrane.

In an instance, the solid electrolyte membrane has a compact structure. Specifically, the solid electrolyte membrane has a compact non-porous structure or a compact non-perforated structure.

In the present disclosure, a composition of the positive electrode electrolyte solution is different from that of the negative electrode electrolyte solution.

In the present disclosure, that the positive electrode electrolyte solution and the negative electrode electrolyte solution are separated by the solid electrolyte membrane means that the positive electrode electrolyte solution and the negative electrode electrolyte solution are separated by the solid electrolyte membrane and are not in contact with each other, but ions may move through the solid electrolyte membrane.

### <Positive Electrode Electrolyte Solution and Negative Electrode Electrolyte Solution>

In some embodiments, the positive electrode electrolyte solution includes a nitrile compound, and a mass fraction of the nitrile compound is not less than 5%.

In some embodiments, that the mass fraction of the nitrile compound is not less than 5% means that a mass percentage of a mass of the nitrile compound to a total mass of the positive electrode electrolyte solution is not less than 5%, that is, greater than or equal to 5%. In this case, the nitrile compound may sufficiently form a protective layer on a surface of a positive electrode active material, to effectively stabilize a transition metal element in the positive electrode active material and prevent the transition metal element from being damaged at a high voltage, thereby improving stability of a positive electrode interface and improving cycling performance. If the mass fraction of the nitrile compound is less than 5%, the nitrile compound can also form a protective layer on the surface of the positive electrode active material to improve the stability of the positive electrode interface, but improvement effect is not apparent.

In some embodiments, the mass fraction of the nitrile compound ranges from 5% to 80%, for example, 5%, 6%, 7%, 8%, 9%, 10%, 20%, 30%, 40%, 50%, 60%, 70%, or 80%.

In some embodiments, the nitrile compound is selected from at least one of acetonitrile, propionitrile, butyronitrile, malononitrile, butanedinitrile, glutaronitrile, adiponitrile, 1,3,6-hexanetricarbonitrile, 1,3,5-pentanetricarbonitrile, ethylene glycol bis (propionitrile) ether, hexafluorocyclotriphosphazene, pentafluoro (ethoxy) cyclotriphosphazene, pentafluoro (phenoxy) cyclotriphosphazene, 1,4-dicyano-2-butene, 4-fluorobenzonitrile, p-tolunitrile, 2-fluorohexanedinitrile, 2,2-difluorobutanedinitrile, benzenetricarbonitrile, acrylonitrile, crotononitrile, fumaronitrile, or trans-hexenedinitrile. Further, the nitrile compound is preferably at least one of acetonitrile or butanedinitrile.

In some embodiments, the negative electrode electrolyte solution includes an ether compound, and a mass fraction of the ether compound is not less than 4%.

In some embodiments, that the mass fraction of the ether compound is not less than 4% means that a mass percentage of a mass of the ether compound to a total mass of the negative electrode electrolyte solution is not less than 4%, that is, greater than or equal to 4%. In this case, because the ether compound has excellent anti-reduction stability, and in particular, the ether compound has relatively high stability with metal lithium, an interface side reaction between the negative electrode electrolyte solution and a negative electrode active material can be effectively suppressed, thereby significantly improving stability of a negative electrode interface and improving cycling performance. If the mass fraction of the ether compound is less than 4%, the ether compound can also improve the stability of the negative electrode interface, but improvement effect is not apparent.

In some embodiments, the mass fraction of the ether compound ranges from 4% to 80%, for example, 4%, 5%, 6%, 7%, 8%, 9%, 10%, 20%, 30%, 40%, 50%, 60%, 70%, or 80%.

In some embodiments, the ether compound is selected from at least one of ethylene glycol dimethyl ether, diethylene glycol dimethyl ether, triethylene glycol dimethyl ether, tetraethylene glycol dimethyl ether, propylene glycol dimethyl ether, dipropylene glycol dimethyl ether, tripropylene glycol dimethyl ether, 1,3-dioxolane, dioxane, tetrahydrofuran, 2-methyl tetrahydrofuran, 3-methyl tetrahydrofuran, 2-ethyl tetrahydrofuran, 3-ethyl tetrahydrofuran, or dimethyl tetrahydrofuran. Further, the ether compound is preferably at least one of ethylene glycol dimethyl ether, diethylene glycol dimethyl ether, propylene glycol dimethyl ether, dipropylene glycol dimethyl ether, 1,3-dioxolane, dioxane, or tetrahydrofuran.

In some embodiments, the positive electrode electrolyte solution further includes a lithium salt A, a solvent A, and an additive A.

In some embodiments, the negative electrode electrolyte solution further includes a lithium salt B, a solvent B, and an additive B.

In some embodiments, a ratio of a liquid retention m1 (unit:g) of the positive electrode electrolyte solution to a design capacity Q (unit:Ah) of the electrochemical apparatus satisfies 0.5 g/Ah≤ m1/Q≤2 g/Ah, for example, 0.5 g/Ah, 1 g/Ah, 1.5 g/Ah, or 2 g/Ah.

In some embodiments, a ratio of a liquid retention m2 (unit:g) of the negative electrode electrolyte solution to the design capacity Q (unit:Ah) of the electrochemical apparatus satisfies 0.5 g/Ah≤ m2/Q≤2 g/Ah, for example, 0.5 g/Ah, 1 g/Ah, 1.5 g/Ah, or 2 g/Ah.

In the present disclosure, the “liquid retention of the positive electrode electrolyte solution” and the “liquid retention of the negative electrode electrolyte solution” may be determined by using a conventional weighing method.

In some embodiments, the liquid retention m1 of the positive electrode electrolyte solution is less than or equal to the liquid retention m2 of the negative electrode electrolyte solution. Because a growth speed of a negative electrode solid electrolyte interphase (SEI) film in the electrochemical apparatus is relatively fast, a consumption speed of the negative electrode electrolyte solution in the electrochemical apparatus is usually faster than a consumption speed of the positive electrode electrolyte solution. Through this setting, the entire electrochemical apparatus may obtain better cycling performance.

In some embodiments, the lithium salt A and the lithium salt B are the same or different, and each are independently selected from one or more of lithium hexafluorophosphate (LiPF₆), lithium tetrafluoroborate (LiBF₄), lithium perchlorate (LiClO₄), lithium hexafluorarsenate (V) (LiAsF₆), lithium hexafluoroantimonate (V) (LiSbF₆), lithium difluorophosphate (LiPF₂O₂), lithium 4,5-dicyano-2-trifluoromethylimidazole (LIDTI), lithium bis(oxalate) borate (LiBOB), lithium bis (malonato) borate (LiBMB), lithium difluorooxalate borate (LiDFOB), lithium bis (difluoromalonato) borate (LiBDFMB), lithium (malonato oxalato) borate (LiMOB), lithium (difluoromalonato oxalato) borate (LiDFMOB), lithium tris (oxalato) phosphate (LiTOP), lithium tris (difluoromalonato) phosphate (LiTDFMP), lithium tetrafluoro (oxalato) phosphate (LiTFOP), lithium bis (oxyalyl) difluorophosphate (LiDFOP), lithium bis (fluorosulfonyl) imide (LiFSI), lithium bis(trifluoromethanesulphonyl) imide (LiTFSI), lithium (fluorosulfonyl) (trifluoromethanesulfonyl) imide (LiN (SO₂F) (SO₂CF₃)), lithium nitrate (LiNO₃), lithium fluoride (LiF), LiN (SO₂CₙF₂ₙ₊₁)₂, or LiN (SO₂F) (SO₂CₘF₂ₘ₊₁) (n is an integer ranging from 2 to 10, and m is an integer ranging from 2 to 10.

In some embodiments, the solvent A and the solvent B are the same or different, and each are independently selected from one or more of ethylene carbonate (EC), propylene carbonate (PC), butylene carbonate, fluoroethylene carbonate (FEC), difluoroethylene carbonate (DFEC), fluorodimethyl carbonate, fluoroethyl methyl carbonate, dimethyl carbonate (DMC), diethyl carbonate (DEC), dipropyl carbonate, ethyl methyl carbonate (EMC), methyl formate, ethyl formate, propyl formate, butyl formate, methyl acetate, ethyl acetate (EA), propyl acetate, butyl acetate, methyl propionate, ethyl propionate, propyl propionate, butyl propanoate, methyl butyrate, ethyl butyrate, propyl butyrate, butyl butyrate, methyl difluoroacetate, ethyl difluoroacetate, γ-butyrolactone (GBL), γ-valerolactone, δ-valerolactone, fluoro-ether F-EPE, fluoro-ether D2, fluoro-ether HFPM, fluoro-ether MFE, fluoro-ether EME, sulfolane, dimethylsulfoxide (DMSO), dichloromethane, or dichloroethane.

In some embodiments, the additive A and the additive B are the same or different, and each are independently selected from one or more of vinylene carbonate (VC), vinyl ethylene carbonate (VEC), 1,3-propane sultone (PS), trifluoromethyl ethylene carbonate, dimethyl sulfate, ethylene sulfate (DTD), methyl ethylene sulfate, propylene sulfate, ethylene sulphite, succinic anhydride, biphenyl, diphenyl ether, toluene, xylene, cyclohexylbenzene, fluorobenzene, p-fluorotoluene, p-fluoroanisole, tert-butylbenzene, tert-amylbenzene, propene sultone, butane sultone, methylene methanedisulfonate, glycol bis (propionitrile) ether, hexamethyldisilazane, heptamethyldisilazane, dimethyl methylphosphonate, diethyl ethylphosphonate, trimethyl phosphate, triethyl phosphate, triphenyl phosphate, triphenyl phosphite, tris (trimethylsilyl) borate, tris (trimethylsilyl) phosphate, 1,2-bis (cyanoethyloxy) ethane, 1,2,3-tri (cyanoethyloxy) propane, 3,3-sulfonyldipropionitrile, or 3-[(trimethylsilyl) oxy]propanenitrile.

In some embodiments, the lithium salt A includes at least 60 wt % lithium hexafluorophosphate. 60 wt % lithium hexafluorophosphate or more lithium hexafluorophosphate may be added, to reduce preparation costs of the electrochemical apparatus when performance of the electrochemical apparatus is ensured.

In some embodiments, the lithium salt B includes at least 50 wt % lithium difluorooxalate borate. 50 wt % lithium difluorooxalate borate or more lithium difluorooxalate borate may be added, to improve stability of the negative electrode SEI film and further improve the cycle life, especially the cycle life of the electrochemical apparatus when metal lithium is used as the negative electrode.

In some embodiments, the lithium salt B includes at least 1 wt % lithium nitrate. 1 wt % lithium nitrate or more lithium nitrate may be added, to improve a proportion of inorganic components in the negative electrode SEI film, thereby improving stability of the negative electrode SEI film and further improving the cycle life, and in particular, improving the cycle life of the electrochemical apparatus when metal lithium is used as the negative electrode.

### <Solid Electrolyte Membrane>

As described above, the solid electrolyte membrane has a compact structure. Specifically, the solid electrolyte membrane has a compact non-porous structure or a compact non-perforated structure.

In some embodiments, the solid electrolyte membrane is an inorganic solid electrolyte membrane with a compact non-perforated structure.

In some embodiments, the solid electrolyte membrane is an inorganic solid electrolyte membrane with a compact non-porous structure.

In some embodiments, a density of the solid electrolyte membrane is greater than or equal to 99%, for example, 99% to 100%.

In the present disclosure, the density of the solid electrolyte membrane may be obtained through a test by using the following method. Specifically, a density calculation formula is: Density=D_{A}/D×100%, where D_{A} is an apparent density of the solid electrolyte membrane, and D is a theoretical density of the solid electrolyte membrane. The apparent density D_{A} of the solid electrolyte membrane may be measured and calculated by using the Archimedes' principle.

In some embodiments, the solid electrolyte membrane is different from a conventional membrane. The solid electrolyte membrane disclosed in the present disclosure has a compact structure, and specifically, a compact non-porous structure or a compact non-perforated structure. Through the setting of the solid electrolyte membrane with this structure, a electrolyte solution cannot pass through the solid electrolyte membrane, but lithium ions in the electrolyte solution can migrate and pass through the solid electrolyte membrane. Therefore, through the setting of the solid electrolyte membrane, it may be ensured that the positive electrode electrolyte solution and the negative electrode electrolyte solution on two sides of the solid electrolyte membrane are separated by the solid electrolyte membrane and are not in contact with each other.

In some embodiments, a thickness of the solid electrolyte membrane preferably ranges from 5 μm to 100 μm. A solid electrolyte membrane whose thickness is less than 5 μm is difficult to be implemented by using an existing preparation technology. In addition, when the thickness is less than 5 μm, the solid electrolyte membrane has excessively low strength and is prone to fractures. As a result, it is difficult to assemble the solid electrolyte membrane into the electrochemical apparatus. A solid electrolyte membrane whose thickness is greater than 100 μm has high mechanical strength. It is easy to assemble the solid electrolyte membrane into the electrochemical apparatus. However, the solid electrolyte membrane with an excessively large thickness reduces an energy density of the electrochemical apparatus.

In some embodiments, an ionic conductivity of the solid electrolyte membrane is greater than or equal to 0.1 ms/cm. Preferably, the ionic conductivity of the solid electrolyte membrane is greater than or equal to 1 ms/cm.

In some embodiments, a material forming the solid electrolyte membrane is at least one of a Garnet-type oxide electrolyte, a NASICON-type oxide electrolyte, a perovskite-type oxide electrolyte, or a sulfide electrolyte.

In some embodiments, the Garnet-type oxide electrolyte is preferably at least one of lithium lanthanum zirconium oxide (LLZO), tantalum-doped lithium lanthanum zirconium oxide (LLZTO), or niobium-doped lithium lanthanum zirconium oxide (LLZNO).

In some embodiments, the NASICON-type oxide electrolyte is selected from at least one of Li_{1+2x′} Zr_{2-x′} Ca_{x′} (PO₄)₃(where 0.1≤x′≤0.4) or Li_{1+x+y}Alₓ(Tiₘ₃Zrₙ₁Geᵣ₁)₂₋ₓSi_{y}P_{3-y}O₁₂ (where 0≤x≤2, 0≤y≤3, 0≤m3≤1, 0≤n1≤1, 0≤r1≤1, and m3+n1+r1=1). The NASICON-type oxide electrolyte is preferably at least one of lithium aluminum titanium phosphate (LATP), lithium aluminum germanium phosphate (LAGP), lithium aluminum germanium titanium phosphate, or lithium zirconium silicon phosphate (Li₃Zr₂Si₂PO₁₂).

In some embodiments, the perovskite-type oxide electrolyte is lithium lanthanum titanium oxide (LLTO).

In some embodiments, the sulfide electrolyte is at least one of Li₃PS₄, Li₇P₃S₁₁, Li₄₋ₓ, Ge_{1-x″} P_{x″}S₄ (x″=0.4 or x″=0.6), or Li₆PS₅X (X is selected from at least one of F, Cl, Br, or I).

In some embodiments, the thickness of the solid electrolyte membrane is 5 μm, 10 μm, m, 30 μm, 40 μm, 50 μm, 60 μm, 70 μm, 80 μm, 90 μm, or 100 μm. Preferably, in some embodiments, the thickness of the solid electrolyte membrane is 15 μm, 20 μm, 25 μm, or 30 μm.

In some embodiments, a method for preparing the solid electrolyte membrane is as follows. Grinding the material forming the solid electrolyte membrane into solid electrolyte powder with a particle size less than 2 μm through ball grinding; then, evenly mixing and dispersing the solid electrolyte powder and a first binder in a first solvent, to obtain a solid electrolyte slurry; coating a polymer-based membrane with the solid electrolyte slurry, and drying the first solvent to obtain a thin composite membrane; taking the thin composite membrane from the polymer-based membrane, and cutting the thin composite membrane according to a required specification; and performing glue removing and sintering on the thin composite membrane in an inert gas atmosphere under a pressure condition and a high temperature condition, to obtain the solid electrolyte membrane. The solid electrolyte membrane prepared by using this method is an all-inorganic solid electrolyte membrane. In addition, because of high-temperature sintering, the solid electrolyte membrane is an inorganic membrane with the compact non-porous structure or the compact non-perforated structure. Therefore, a liquid cannot directly pass through the solid electrolyte membrane.

A temperature of the glue removing ranges from 200° C. to 1400° C. (for example, 200° C., 300° C., 400° C., 500° C., 600° C., 700° C., 800° C., 900° C., 1000° C., 1100° C., 1200° C., 1300° C., or 1400° C.), and is specifically set based on a type of the first binder.

A temperature of the sintering ranges from 200° C. to 1400° C. (for example, 200° C., 300° C., 400° C., 500° C., 600° C., 700° C., 800° C., 900° C., 1000° C., 1100° C., 1200° C., 1300° C., or 1400° C.), and is specifically set based on a type of the material forming the solid electrolyte membrane.

The pressure ranges from 10 MPa to 300 MPa (for example, 10 MPa, 20 MPa, 30 MPa, 40 MPa, 50 MPa, 60 MPa, 70 MPa, 80 MPa, 90 MPa, 100 MPa, 200 MPa, or 300 MPa).

The first binder and the first solvent are not specially limited, and may be preferably selected based on the type of the material forming the solid electrolyte membrane.

The first binder is preferably one or more of polyvinylidene fluoride (PVDF), polyoxyethylene, poly(vinyl alcohol), polyvinyl butyral (PVB), ethyl cellulose (EC), or acrylic-based resin.

The first solvent is preferably one or more of N-methylpyrrolidone (NMP), water, acetonitrile, or toluene.

### <Positive Electrode Sealing Ring and Negative Electrode Sealing Ring>

In some embodiments, a positive electrode sealing ring is disposed between the positive electrode plate and the solid electrolyte membrane, and is configured to prevent the positive electrode electrolyte solution from leaking from an edge of the positive electrode plate.

In some embodiments, a negative electrode sealing ring is disposed between the negative electrode plate and the solid electrolyte membrane, and is configured to prevent the negative electrode electrolyte solution from leaking from the edge of the negative electrode plate.

In some embodiments, through the setting of the positive electrode sealing ring and the negative electrode sealing ring, it needs to be ensured that the electrolyte solution cannot permeate. A material (or defined as a sealant) forming the positive electrode sealing ring and a material (or defined as a sealant) forming the negative electrode sealing ring are the same or different, and each are preferably at least one of maleic anhydride grafted polypropylene, polyurethane, nitrile butadiene rubber (NBR), butyl rubber, polychloroprene, epoxy resin, or silicone rubber.

In some embodiments, the positive electrode sealing ring may be formed through performing melting and bonding or curing and bonding on a material forming the positive electrode sealing ring.

In some embodiments, the negative electrode sealing ring may be formed through performing melting and bonding or curing and bonding on a material forming the negative electrode sealing ring.

### <Positive Electrode Plate and Negative Electrode Plate>

In some embodiments, the positive electrode plate includes a positive electrode current collector, a positive electrode coating region disposed on at least one side surface of the positive electrode current collector, and a positive electrode sealing region that is located on a periphery of the positive electrode coating region and connected to the positive electrode coating region; and a positive electrode coating paste is disposed in the positive electrode coating region, and the positive electrode sealing ring is disposed in the positive electrode sealing region.

In some embodiments, the negative electrode plate includes a negative electrode current collector, a negative electrode coating region disposed on at least one side surface of the negative electrode current collector, and a negative electrode sealing region that is located on a periphery of the negative electrode coating region and connected to the negative electrode coating region; and a negative electrode coating paste is disposed in the negative electrode coating region, and the negative electrode sealing ring is disposed in the negative electrode sealing region.

In some embodiments, the positive electrode active material in the positive electrode plate may use a positive electrode active material that is known in the art and can implement reversible intercalation/deintercalation of ions. For example, the positive electrode active material is lithium-containing transition metal composite oxide, and transition metal may be one or more of Mn, Fe, Ni, Co, Cr, Ti, Zn, V, Al, Zr, Ce, or Mg. The lithium-containing transition metal composite oxide may be further doped with an element with large electronegativity, for example, one or more of S, F, Cl, or I, so that the positive electrode active material may have relatively high structural stability and electrochemical performance. For example, the lithium-containing transition metal composite oxide is one or more of LiMₙ₂O₄, LiNiO₂, LiCoO₂, LiNi_{1-y1}Co_{y1}O₂ (0<y1<1), LiNiₐCO_{b}Al_{1-a-b}O₂ (0<a<1, 0<b<1, and 0<a+b<1), LiMₙ₁₋ₘ₄₋ₙ₂Niₘ₄Coₙ₂O₂(0<m4<1, 0<n2<1, and 0<m4+n2<1), LiMPO₄ (M may be one or more of Fe, Mn, or Co), or Li₃V₂(PO₄)₃. Optionally, the positive electrode plate may further include a conductive agent. Optionally, the positive electrode plate may further include a second binder. For example, the second binder is at least one of PVDF, polytetrafluoroethylene (PTFE), styrene-butadiene rubber (SBR), NBR, water-based acrylic resin, poly(vinyl alcohol), polyvinyl butyral, polyurethane, fluorinated rubber, carboxymethyl cellulose (CMC), or polyacrylic acid (PAA). The positive electrode plate may be prepared by using a conventional method in the art. Usually, the positive electrode active material, the optional conductive agent, and the optional second binder are dispersed in a second solvent (for example, NMP), to form a uniform positive electrode slurry; the positive electrode coating region of the positive electrode current collector is coated with the positive electrode slurry; and processes such as drying are performed, to form a positive electrode coating paste. In this way, the positive electrode plate is obtained.

In some embodiments, the negative electrode active material in the negative electrode plate may use a negative electrode active material known in the art. For example, the negative electrode active material may be one or more of metal lithium, natural graphite, artificial graphite, mesocarbon microbeads (MCMB), hard carbon, soft carbon, silicon, a silicon-carbon composite, SiO, Li—Sn alloy, Li—Sn—O alloy, Sn, SnO, SnO₂, spinel-structure lithium titanate, or Li—Al alloy. Optionally, the negative electrode plate may further include a conductive agent. Optionally, the negative electrode plate may further include a third binder. For example, the third binder includes but is not limited to at least one of PVDF, PTFE, SBR, NBR, water-based acrylic resin, poly(vinyl alcohol), polyvinyl butyral, polyurethane, fluorinated rubber, CMC, PAA, epoxy resin, hydroxypropyl cellulose, cellulose acetate, polyvinyl chloride, carboxylated polyvinyl chloride, polyvinylpyrrolidone, or nylon. Optionally, the negative electrode plate may further include a thickener. For example, the thickener includes but is not limited to sodium carboxymethyl cellulose. The negative electrode plate may be prepared by using a conventional method in the art. Usually, the negative electrode active material, the optional conductive agent, the optional third binder, and the optional thickener are dispersed in a third solvent (for example, water), to form a uniform negative electrode slurry; the negative electrode coating region of the negative electrode current collector is coated with the negative electrode slurry; and processes such as drying are performed, to form a negative electrode coating paste. In this way, the negative electrode plate is obtained.

To obtain a higher energy density, the negative electrode plate is preferably a metal lithium negative electrode plate and/or a negative electrode plate containing metal lithium. A preparation method of the negative electrode plate is as follows. In a low-humidity environment (usually in a drying chamber with a dew point temperature lower than −30° C.), a commercialized metal lithium strip (foil) and/or lithium alloy strip (foil), and copper foil (mesh) are mechanically pressed by using a roller press or another press-fitting device, so that the metal lithium strip (foil) and/or the lithium alloy strip (foil), and the copper foil (mesh) are closely attached to each other. A blank region on an edge of the copper foil (mesh) is used for subsequent welding of a tab.

In some embodiments, the conductive agent in the positive electrode plate includes, but is not limited to, a carbon-based material, a metal-based material, a conductive polymer, or a mixture thereof. In some embodiments, the carbon-based material is selected from natural graphite, artificial graphite, carbon black, acetylene black, ketjen black, a carbon fiber, or any combination thereof. In some embodiments, the metal-based material is selected from at least one of metal powder, a metal fiber, copper, nickel, aluminum, or silver. In some embodiments, the conductive polymer is a polyphenylene derivative.

In some embodiments, the conductive agent in the negative electrode plate includes, but is not limited to, a carbon-based material, a metal-based material, a conductive polymer, or a mixture thereof. In some embodiments, the carbon-based material is selected from natural graphite, artificial graphite, carbon black, acetylene black, ketjen black, a carbon fiber, or any combination thereof. In some embodiments, the metal-based material is selected from at least one of metal powder, a metal fiber, copper, nickel, aluminum, or silver. In some embodiments, the conductive polymer is a polyphenylene derivative.

In some embodiments, the positive electrode current collector in the positive electrode plate includes, but is not limited to, aluminum foil, aluminum foil coated with carbon, perforated aluminum foil, stainless steel foil, a polymer substrate coated with conductive metal, or any combination thereof.

In some embodiments, the negative electrode current collector in the negative electrode plate includes, but is not limited to, copper foil, copper foil coated with carbon, perforated copper foil, nickel foil, stainless steel foil, titanium foil, nickel foam, copper foam, a polymer substrate coated with conductive metal, or any combination thereof.

### <Battery or Super Capacitor>

In some embodiments, the electrochemical apparatus may be a battery (for example, a lithium-ion battery) or a super capacitor.

In some embodiments, an assembly method of the battery is as follows. In a low-humidity environment (usually in a drying chamber with a dew point temperature lower than −30° C.), the positive electrode electrolyte solution is evenly added dropwise to the positive electrode coating paste in the positive electrode plate, then the positive electrode sealing region on the periphery of the positive electrode coating region is coated with a sealant (that is, the material forming the positive electrode sealing ring), and the solid electrolyte membrane is laminated on the positive electrode plate and the solid electrolyte membrane and the positive electrode plate are bonded by using the sealant. The negative electrode electrolyte solution is evenly added dropwise to the negative electrode coating paste in the negative electrode plate, then the negative electrode sealing region on the periphery of the negative electrode coating region is coated with a sealant (that is, the material forming the negative electrode sealing ring), and the negative electrode plate is laminated on the solid electrolyte membrane and the negative electrode plate and the solid electrolyte membrane are bonded by using the sealant. The solid electrolyte membrane is located between the positive electrode plate and the negative electrode plate for separation. After multi-layer lamination, a laminated electrochemical cell may be obtained. The battery may be obtained by welding the electrochemical cell to positive and negative tabs, placing the electrochemical cell in the packaging case, and performing storing, formation, and sorting.

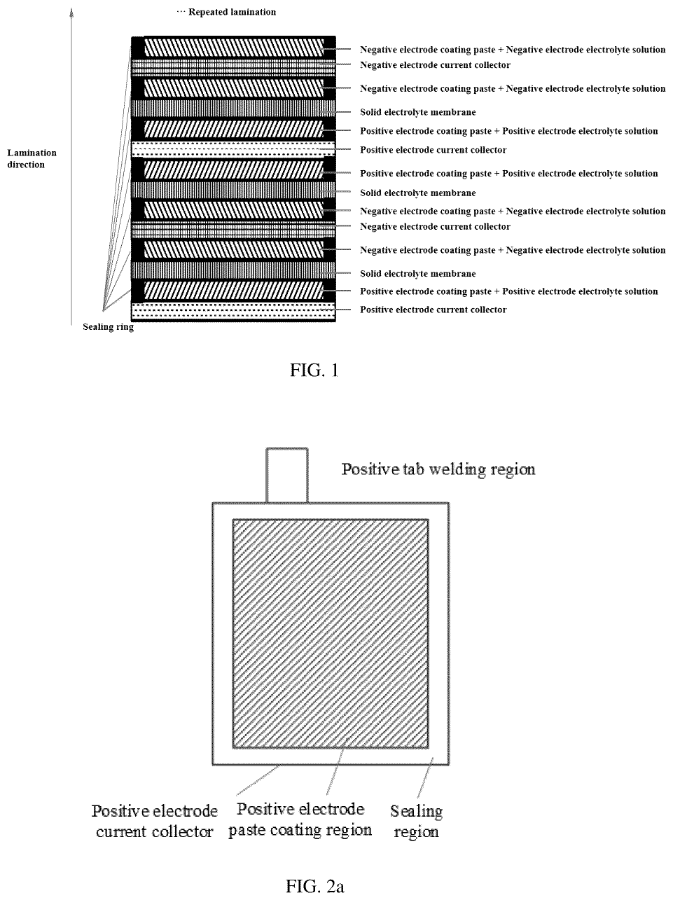

FIG. 1 is a cross-sectional view (a cross-sectional view in a vertical laminated direction) of a structure of a lithium-ion battery. The positive electrode current collector, the positive electrode coating paste (fully infiltrated with the positive electrode electrolyte solution), the solid electrolyte membrane, the negative electrode coating paste (fully infiltrated with a negative electrode electrolyte solution), the negative electrode current collector, the negative electrode coating paste (fully infiltrated with the negative electrode electrolyte solution), the solid electrolyte membrane, the positive electrode coating paste (fully infiltrated with the positive electrode electrolyte solution), the positive electrode current collector, the positive electrode coating paste (fully infiltrated with the positive electrode electrolyte solution), the solid electrolyte membrane, the negative electrode coating paste (fully infiltrated with the negative electrode electrolyte solution), the negative electrode current collector, the negative electrode coating paste (fully infiltrated with the negative electrode electrolyte solution), . . . , and the like are laminated. The sealing regions on the edges of the positive electrode coating paste and the negative electrode coating paste are both covered with the sealant. The positive electrode plate and the negative electrode plate are bonded with the solid electrolyte membrane. In this way, the battery is formed.

In the lamination structure herein, a quantity of layers of negative electrode plates is n, and a quantity of layers of positive electrode plates is n+1, that is, positive electrode plates are disposed on two ends of the lamination structure. Alternatively, a lamination manner may be changed, so that a quantity of layers of positive electrode plates is n, and a quantity of layers of negative electrode plates is n+1, that is, negative electrode plates are disposed on two ends of the lamination structure. Alternatively, a lamination manner may be changed, so that a quantity of layers of positive electrode plates is n, and a quantity of layers of negative electrode plates is n, that is, a negative electrode plate is disposed on one of two ends of the lamination structure, and a positive electrode plate is disposed on the other one of the two ends of the lamination structure, where n is an integer greater than or equal to 1.

It may be learned from the lamination structure that the coating paste on only one surface of an electrode plate on each of the two ends of the lamination structure may be used and participate in a battery charging/discharging reaction. Usually, for facilitating manufacturing, the electrode plates on two ends also use internally same electrode plates that each are coated with the paste on both sides. To further save space and increase energy density, electrode plates that each are coated with the paste on one side (the coating paste faces inward) are selected as the electrode plates on the two ends.

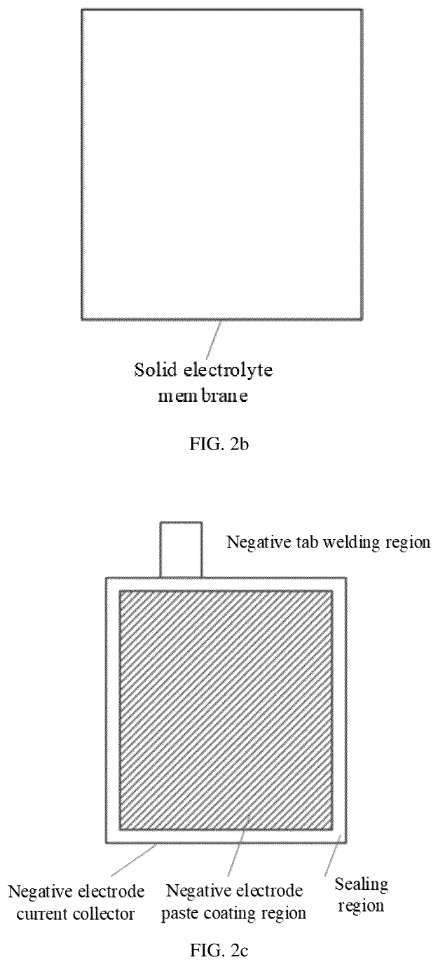

FIG. 2a, FIG. 2b and FIG. 2c constitute an expanded diagram of a lamination unit of a lithium-ion battery (a top view in a lamination direction). FIG. 2a is a schematic diagram of a positive electrode plate (a top view in a lamination direction). A positive electrode coating paste is located in a central region of the electrode plate. A positive electrode current collector at blank edges around the positive electrode coating paste is a sealing region. In the sealing region, a surface of the positive electrode current collector is coated with a sealant. FIG. 2b is a schematic diagram of a solid electrolyte membrane (a top view in a lamination direction). FIG. 2c is a schematic diagram of a negative electrode plate (a top view in a lamination direction). A negative electrode coating paste is located in a central region of the electrode plate. A negative electrode current collector at blank edges around the negative electrode coating paste is a sealing region. In the sealing region, a surface of the negative electrode current collector is coated with a sealant. Positive electrode coating paste region≤Negative electrode coating paste region (herein, ≤ means that the positive electrode coating paste region after lamination may be fully covered by the negative electrode coating paste region). Negative electrode plate≤Solid electrolyte membrane (herein, ≤means that the negative electrode plate after lamination can be fully covered by the solid electrolyte membrane).

### <Use of an Electrochemical Apparatus>

The present disclosure further provides use of the electrochemical apparatus, and does not particularly limit the use of the electrochemical apparatus described in the present disclosure. The electrochemical apparatus may have various well-known uses. For example, the electrochemical apparatus is a mobile computer, a notebook computer, a portable telephone, an e-book player, a portable fax machine, a portable copier, a portable printer, a stereo headset, a video recorder, a liquid crystal television, a portable cleaner, a calculator, a storage card, a portable recorder, a radio, a standby power supply, a car, a motorcycle, an electric vessel, a bicycle, a lighting appliance, a toy, a game console, a clock, an electric tool, a camera, a large household battery, an energy storage power station, or the like.

### EXAMPLES AND COMPARATIVE EXAMPLES

For simplicity, only some numerical ranges are explicitly disclosed herein. However, any lower limit may be combined with any upper limit to form a range not expressly recorded; any lower limit may be combined with any other lower limit to form a range not expressly recorded; and any upper limit may be combined with any other upper limit to form a range not expressly recorded. In addition, although not expressly recorded, each point or individual value between endpoints of a range is included in the range. Therefore, each point or individual value may be used as its own lower limit or upper limit to be combined with any other point or individual value or combined with any other lower limit or upper limit to form a range not expressly recorded.

In the description of this specification, it should be noted that, unless otherwise stated, “more than” and “less than” are inclusive of the present number, and “more” in “one or more” means more than two.

The content of the present disclosure is not intended to describe each disclosed embodiment or implementation of the present disclosure. The following description uses more specific examples to describe exemplary implementations. Throughout this application, guidance is provided by using a series of embodiments and the embodiments may be used in various combinations. In the examples, enumeration is merely representative but should not be interpreted as exhaustive.

The content disclosed in the present disclosure is further described in detail in the following examples and comparative examples. These examples are intended only for illustrative purposes because various modifications and changes made without departing from the scope of the content disclosed in the present disclosure are apparent to a person skilled in the art. Unless otherwise stated, all parts, percentages, and ratios reported in the following examples are based on masses, all reagents used in the examples are commercially available or synthesized in a conventional manner, and can be used directly without further treatment, and all instruments used in the examples are commercially available.

### Preparation Example 1

### (1) Preparation of a Positive Electrode Plate

972 g of a positive electrode active material: lithium cobalt oxide, 14 g of a conductive agent: carbon black, and 14 g of a second binder: PVDF were respectively weighed and dispersed in 400 g NMP, and then fully stirred to form a uniform positive electrode slurry. Positive electrode current collector aluminum foil was coated with the positive electrode slurry, and then dried, rolled, and cut, to obtain a positive electrode plate.

### (2) Preparation of a Negative Electrode Plate

Preparation of a conventional negative electrode plate: 970 g of a negative electrode active material (graphite and/or silicon monoxid and/or a silicon-carbon composite material), 10 g of a conductive agent: carbon black, 10 g of a third binder: SBR (the third binder is weighed in a solid form), and 10 g of a thickener: sodium carboxymethyl cellulose were weighed and dispersed in 1100 g of deionized water, and fully stirred to form a uniform negative electrode slurry. Negative electrode current collector copper foil was coated with the negative electrode slurry, and dried, rolled, and cut, to obtain a negative electrode plate.

Preparation of a metal lithium negative electrode plate: In a low-humidity environment (this experiment is conducted in a drying chamber with a dew point temperature of −40° C.), a commercial metal lithium strip (foil), a lithium alloy strip (foil), and copper foil (mesh) were mechanically pressed by using a roller press or another press-fitting device, so that the metal lithium strip (foil), the lithium alloy strip (foil), and the copper foil (mesh) were closely attached to each other. A blank region on an edge of the copper foil (mesh) was used for subsequent welding of a tab. A negative electrode plate was obtained through cutting.

### (3) Preparation of a Solid Electrolyte Membrane

### a. Preparation of a Lithium Lanthanum Zirconium Tantalum Oxide (LLZTO) Solid Electrolyte Membrane

\textcircled{1} 200 g of a lithium lanthanum zirconium tantalum oxide solid electrolyte was taken and put in a ball mill tank filled with nitrogen gas, and then put in a ball mill device whose rotation speed was set to 800 rpm. After 12 h of fully ball milling, lithium lanthanum zirconium tantalum oxide solid electrolyte powder whose average particle size is 600 nm was obtained. @ 96 g of the lithium lanthanum zirconium tantalum oxide solid electrolyte powder obtained in step 0, 4 g of polyoxyethylene whose molecular mass is 5 μmillion, and 200 g of acetonitrile were weighed and fully mixed and dispersed, to obtain a solid electrolyte slurry. @ A PET-based membrane was coated with the solid electrolyte slurry obtained in step @, and a solvent was dried to obtain a thin composite membrane. The thin composite membrane was taken from the PET-based membrane and cut according to a required specification. In an argon gas atmosphere, glue removing (to fully decompose the binder) was performed for 6 h under a condition of 300° C. and a pressure condition of 20 MPa. Then, sintering was performed at 1200° C. and 300 MPa to obtain a thin solid electrolyte membrane with a thickness of 30 μm and an ionic conductivity of 1.3 ms/cm at a room temperature (25° C.).

### b. Preparation of a Li₆PS₅Cl Solid Electrolyte Membrane

\textcircled{1} 200 g of a Li₆PS₅Cl solid electrolyte was taken and put in a ball mill tank filled with argon gas, and then put in a ball mill device whose rotation speed was set to 800 rpm. After 24 h of fully ball milling, Li₆PS₅Cl solid electrolyte powder whose average particle size is 800 nm was obtained. \textcircled{2} 97 g of the Li₆PS₅Cl solid electrolyte powder obtained in step \textcircled{1}, 3 g of nitrile butadiene rubber whose molecular mass is about 500 thousand, and 150 g of toluene were weighed and fully mixed and dispersed, to obtain a solid electrolyte slurry. \textcircled{3} A PTFE-based membrane was coated with the solid electrolyte slurry obtained in step \textcircled{2}, and a solvent was dried to obtain a thin composite membrane. The thin composite membrane was taken from the PTFE-based membrane and cut according to a required specification. In an argon gas atmosphere, glue removing (to fully decompose the binder) was performed for 10 h under a condition of 350° C. and a pressure condition of 25 MPa. Then, sintering was performed at 550° C. and 300 MPa to obtain a thin solid electrolyte membrane with a thickness of 30 μm and an ionic conductivity of 4.6 ms/cm at a room temperature (25° C.).

### c. Test Method of an Ionic Conductivity

The test method of the ionic conductivity is as follows. The solid electrolyte membrane was punched into a round sheet with a radius of r=8 μmm by using a punching machine. Then, gold spraying was performed on two sides of the round sheet of the solid electrolyte membrane by using an ion sputtering instrument. A round stainless steel (SS) sheet with a radius of r=8 μmm was placed on each of the two sides of the round sheet of the solid electrolyte membrane after gold spraying. Sealing and assembling were performed to obtain an SS/solid electrolyte membrane/SS symmetric blocking electrode. An electrochemical workstation conducted an Electrochemical Impedance Spectroscopy (EIS) test on the foregoing symmetric blocking battery. Test conditions are as follows. An amplitude is 10 μmV, a frequency ranges from 10 Hz to 106 Hz, and a temperature is 25° C. Before the test, the battery was set aside at the test temperature for 1 h to stabilize the battery, to obtain an impedance spectrum and perform data fitting, thereby obtaining a bulk resistance Rb. A conductivity of the solid electrolyte membrane may be calculated according to the following equation: δ=d/(Rb×S).

Herein, 6 is the conductivity of the solid electrolyte membrane, Rb is the bulk resistance obtained through fitting on impedance spectrum data, d is a thickness of the solid electrolyte membrane, S is an electrode area, and S=πr².

### (4) Preparation of an Electrolyte Solution

### a. Preparation of a Positive Electrode Electrolyte Solution

A lithium salt A, a solvent A, an additive A, and a nitrile compound were evenly mixed in a specific mass ratio in a glove box that was filled with argon gas and in which a water content is less than 1 ppm.

### b. Preparation of a Negative Electrode Electrolyte Solution

A lithium salt B, a solvent B, an additive B, and an ether compound were evenly mixed in a specific mass ratio in a glove box that was filled with argon gas and in which a water content is less than 1 ppm.

### C. Preparation of an Electrolyte Solution in a Comparative Group

The positive electrode electrolyte solution and the negative electrode electrolyte solution were taken and evenly mixed in a mass ratio of 1:1, to obtain the electrolyte solution in a comparative group.

TABLE 1-1
Proportion of the electrolyte solution

| | | | | Ethylene | | | |
|---|---|---|---|---|---|---|---|
| | | | | glycol | Diethylene glycol | | |
| Electrolyte | Acetonitrile | Butanedinitrile | Adiponitrile | dimethyl ether | dimethyl ether | Dioxane | Tetrahydrofuran |
| solution | (%) | (%) | (%) | (%) | (%) | (%) | (%) |
| Z1 | 80 | 0 | 0 | 0 | 0 | 0 | 0 |
| Z2 | 5 | 0 | 0 | 0 | 0 | 0 | 0 |
| Z3 | 0 | 30 | 0 | 0 | 0 | 0 | 0 |
| Z4 | 0 | 30 | 0 | 0 | 0 | 0 | 0 |
| Z5 | 0 | 30 | 0 | 0 | 0 | 0 | 0 |
| Z6 | 0 | 5 | 0 | 0 | 0 | 0 | 0 |
| Z7 | 40 | 40 | 0 | 0 | 0 | 0 | 0 |
| Z8 | 50 | 35 | 0 | 0 | 0 | 0 | 0 |
| Z9 | 82 | 0 | 0 | 0 | 0 | 0 | 0 |
| Z10 | 0 | 50 | 0 | 0 | 0 | 0 | 0 |
| Z11 | 40 | 40 | 0 | 0 | 0 | 0 | 0 |
| Z12 | 0 | 0 | 50 | 0 | 0 | 0 | 0 |
| Z13 | 3 | 0 | 0 | 0 | 0 | 0 | 0 |
| Z14 | 0 | 0 | 0 | 0 | 0 | 0 | 0 |
| F1 | 0 | 0 | 0 | 80 | 0 | 0 | 0 |
| F2 | 0 | 0 | 0 | 80 | 0 | 0 | 0 |
| F3 | 0 | 0 | 0 | 80 | 0 | 0 | 0 |
| F4 | 0 | 0 | 0 | 70 | 0 | 0 | 0 |
| F5 | 0 | 0 | 0 | 70 | 0 | 0 | 0 |
| F6 | 0 | 0 | 0 | 70 | 0 | 0 | 0 |
| F7 | 0 | 0 | 0 | 60 | 0 | 0 | 0 |
| F8 | 0 | 0 | 0 | 60 | 0 | 0 | 0 |
| F9 | 0 | 0 | 0 | 0 | 60 | 0 | 0 |
| F10 | 0 | 0 | 0 | 0 | 0 | 60 | 0 |
| F11 | 0 | 0 | 0 | 0 | 0 | 0 | 60 |
| F12 | 0 | 0 | 0 | 0 | 0 | 0 | 0 |
| F13 | 0 | 0 | 0 | 3 | 0 | 0 | 0 |
| F14 | 0 | 0 | 0 | 0 | 0 | 0 | 0 |

TABLE 1-2
Proportion of the electrolyte solution

| Electrolyte | 1,3-dioxolane | LiPF₆ | LiDFOB | LiFSI | Lithium nitrate | FEC | PC | DEC | PS | VC |
|---|---|---|---|---|---|---|---|---|---|---|
| solution | (%) | (%) | (%) | (%) | (%) | (%) | (%) | (%) | (%) | (%) |
| Z1 | 0 | 15 | 0 | 0 | 0 | 1 | 2 | 0 | 2 | 0 |
| Z2 | 0 | 12 | 0 | 2 | 0 | 2 | 30 | 47 | 2 | 0 |
| Z3 | 0 | 9 | 0 | 6 | 0 | 5 | 10 | 38 | 2 | 0 |
| Z4 | 0 | 7 | 0 | 8 | 0 | 5 | 10 | 38 | 2 | 0 |
| Z5 | 0 | 0 | 0 | 15 | 0 | 5 | 10 | 38 | 2 | 0 |
| Z6 | 0 | 12 | 0 | 3 | 0 | 1 | 30 | 47 | 2 | 0 |
| Z7 | 0 | 10 | 1 | 2 | 0 | 5 | 0 | 0 | 1 | 1 |
| Z8 | 0 | 15 | 0 | 0 | 0 | 0 | 0 | 0 | 0 | 0 |
| Z9 | 0 | 18 | 0 | 0 | 0 | 0 | 0 | 0 | 0 | 0 |
| Z10 | 0 | 0 | 2 | 18 | 0 | 30 | 0 | 0 | 0 | 0 |
| Z11 | 0 | 10 | 0 | 2 | 0 | 8 | 0 | 0 | 0 | 0 |
| Z12 | 0 | 0 | 2 | 18 | 0 | 30 | 0 | 0 | 0 | 0 |
| Z13 | 0 | 12 | 0 | 2 | 0 | 2 | 30 | 49 | 2 | 0 |
| Z14 | 0 | 12 | 0 | 2 | 0 | 2 | 30 | 52 | 2 | 0 |
| F1 | 0 | 0 | 20 | 0 | 0 | 0 | 0 | 0 | 0 | 0 |
| F2 | 0 | 0 | 0 | 20 | 0 | 0 | 0 | 0 | 0 | 0 |
| F3 | 0 | 0 | 5 | 15 | 0 | 0 | 0 | 0 | 0 | 0 |
| F4 | 0 | 0 | 10 | 10 | 0 | 10 | 0 | 0 | 0 | 0 |
| F5 | 0 | 0 | 10 | 9 | 1 | 10 | 0 | 0 | 0 | 0 |
| F6 | 0 | 0 | 10 | 5 | 5 | 10 | 0 | 0 | 0 | 0 |
| F7 | 0 | 0 | 20 | 0 | 2 | 5 | 12 | 0 | 0 | 1 |
| F8 | 0 | 3 | 17 | 0 | 2 | 5 | 12 | 0 | 0 | 1 |
| F9 | 0 | 0 | 13 | 0 | 2 | 5 | 0 | 12 | 0 | 1 |
| F10 | 0 | 0 | 13 | 0 | 2 | 5 | 0 | 12 | 0 | 1 |
| F11 | 0 | 0 | 13 | 0 | 2 | 5 | 0 | 12 | 0 | 1 |
| F12 | 60 | 0 | 13 | 0 | 2 | 0 | 5 | 12 | 0 | 1 |
| F13 | 0 | 0 | 20 | 0 | 2 | 25 | 12 | 36 | 0 | 1 |
| F14 | 0 | 0 | 20 | 0 | 2 | 25 | 12 | 40 | 0 | 1 |

In Table 1-1 and Table 1-2, Z1 to Z14 are positive electrode electrolyte solutions, and F1 to F14 are negative electrode electrolyte solutions. 50% Z1 and 50% F1 were weighed and evenly mixed to obtain an electrolyte solution, that is, H1. 50% Z2 and 50% F2 were weighed and evenly mixed to obtain an electrolyte solution, that is, H2. By analogy, electrolyte solutions H3 to H14 were obtained. 50% Z1 and 50% F9 were weighed and evenly mixed to obtain an electrolyte solution, that is, H15. 50% Z2 and 50% F10 were weighed and evenly mixed to obtain an electrolyte solution, that is, H16. 50% Z3 and 50% F11 were weighed and evenly mixed to obtain an electrolyte solution, that is, H17. 50% Z4 and 50% F12 were weighed and evenly mixed to obtain an electrolyte solution, that is, H18.

### (5) Preparation of a Lithium-Ion Battery

In a low-humidity environment (this experiment was conducted in a drying chamber with a dew point temperature lower than −40° C.), the positive electrode electrolyte solution was evenly added dropwise to a positive electrode coating paste in the positive electrode plate, then a positive electrode sealing region on a periphery of a positive electrode coating region was coated with a sealant (that is, a material forming a positive electrode sealing ring), and the solid electrolyte membrane was laminated on the positive electrode plate and the solid electrolyte membrane and the positive electrode plate were bonded by using the sealant. The negative electrode electrolyte solution was evenly added dropwise to a negative electrode coating paste in the negative electrode plate, then a negative electrode sealing region on a periphery of a negative electrode coating region was coated with a sealant (that is, a material forming a negative electrode sealing ring), and the negative electrode plate was laminated on the solid electrolyte membrane and the negative electrode plate and the solid electrolyte membrane were bonded by using the sealant. The solid electrolyte membrane was located between the positive electrode plate and the negative electrode plate for separation. After 11 layers of positive electrode plates, 20 layers of solid electrolyte membranes, and 10 layers of negative electrode plates were alternately laminated, a laminated electrochemical cell can be obtained. The battery can be obtained by welding the electrochemical cell to positive and negative tabs, placing the electrochemical cell in a packaging case, and performing storing, formation, and sorting.

### (6) Preparation of a Conventional Lithium-Ion Battery

The positive electrode plate, the negative electrode plate, and a PP separator (with a thickness of 20 μm) were laminated by using a laminator to obtain a conventional electrochemical cell. The conventional lithium-ion battery can be obtained by welding the conventional electrochemical cell to positive and negative tabs, placing the conventional electrochemical cell in a packaging case, and performing sealing, electrolyte solution injection, storing, formation, and sorting.

### 2. Battery Performance Test

Normal-temperature cycle life: A lithium-ion battery was placed at 25° C., discharged at a constant current of 0.5 C to a lower limit voltage (3.0 V), and set aside for 5 μminutes. Then, the lithium-ion battery was charged at a constant current of 0.5 C to an upper limit voltage (4.5 V), then charged at a constant voltage of 4.5 V to a current of 0.05 C, and set aside for 5 μminutes. Next, the lithium-ion battery was discharged at a constant current of 0.5 C to a voltage of 3.0 V, and set aside for 5 μminutes. This is a charging/discharging cycle. Charging/discharging was performed in this way, until a ratio of a discharge capacity in a specific cycle to an initial discharge capacity is less than or equal to 80%. A quantity of conducted cycles is the cycle life.

TABLE 2
Battery information and performance test

| | Positive | Negative | | Positive | | Negative | | | Normal |
|---|---|---|---|---|---|---|---|---|---|
| | electrode | electrode | Solid | electrode | liquid | electrode | liquid | | temperature |
| | active | active | electrolyte | electrolyte | retention | electrolyte | retention | Sealing ring | cycle life |
| | material | material | membrane | solution | m1, g/Ah | solution | m2, g/Ah | material | (cycles) |
| Example 1 | Lithium | Metal lithium | LLZTO | Z1 | 0.6 | F1 | 0.8 | Polyurethane | 631 |
| | cobalt oxide | | | | | | | | |
| Example 2 | Lithium | Metal lithium | LLZTO | Z2 | 0.6 | F2 | 0.8 | Polyurethane | 623 |
| | cobalt oxide | | | | | | | | |
| Example 3 | Lithium | Metal lithium | LLZTO | Z3 | 0.6 | F3 | 0.8 | Polyurethane | 617 |
| | cobalt oxide | | | | | | | | |
| Example 4 | Lithium | Metal lithium | LLZTO | Z4 | 0.6 | F4 | 0.8 | Polyurethane | 630 |
| | cobalt oxide | | | | | | | | |
| Example 5 | Lithium | Metal lithium | LLZTO | Z5 | 0.6 | F5 | 0.8 | Polyurethane | 683 |
| | cobalt oxide | | | | | | | | |
| Example 6 | Lithium | Metal lithium | LLZTO | Z6 | 0.6 | F6 | 0.8 | Polyurethane | 691 |
| | cobalt oxide | | | | | | | | |
| Example 7 | Lithium | Metal lithium | LLZTO | Z7 | 0.6 | F7 | 0.8 | Polyurethane | 689 |
| | cobalt oxide | | | | | | | | |
| Example 8 | Lithium | Metal lithium | LLZTO | Z8 | 0.6 | F8 | 0.8 | Polyurethane | 694 |
| | cobalt oxide | | | | | | | | |
| Example 9 | Lithium | Metal lithium | LLZTO | Z9 | 0.6 | F9 | 0.8 | Polyurethane | 688 |
| | cobalt oxide | | | | | | | | |
| Example 10 | Lithium | Metal lithium | LLZTO | Z10 | 0.6 | F10 | 0.8 | Polyurethane | 639 |
| | cobalt oxide | | | | | | | | |
| Example 11 | Lithium | Metal lithium | LLZTO | Z11 | 0.6 | F11 | 0.8 | Polyurethane | 690 |
| | cobalt oxide | | | | | | | | |
| Example 12 | Lithium | Metal lithium | LLZTO | Z12 | 0.6 | F12 | 0.8 | Polyurethane | 638 |
| | cobalt oxide | | | | | | | | |
| Example 13 | Lithium | Metal lithium | LLZTO | Z13 | 0.6 | F13 | 0.8 | Polyurethane | 551 |
| | cobalt oxide | | | | | | | | |
| Example 14 | Lithium | Metal lithium | LLZTO | Z14 | 0.6 | F14 | 0.8 | Polyurethane | 445 |
| | cobalt oxide | | | | | | | | |
| Example 15 | Lithium | Silicon | LLZTO | Z1 | 0.6 | F9 | 1.1 | Polyurethane | 923 |
| | cobalt oxide | monoxide | | | | | | | |
| Example 16 | Lithium | Silicon- | LLZTO | Z2 | 0.6 | F10 | 1.2 | Polyurethane | 892 |
| | cobalt oxide | carbon | | | | | | | |
| | | composite | | | | | | | |
| | | material | | | | | | | |
| Example 17 | Lithium | Graphite | LLZTO | Z3 | 0.6 | F11 | 1.0 | Polyurethane | 1446 |
| | cobalt oxide | | | | | | | | |
| Example 18 | Lithium | Lithium | LLZTO | Z4 | 0.6 | F12 | 0.6 | Polyurethane | 778 |
| | cobalt oxide | indium alloy | | | | | | | |
| | | (40 wt % | | | | | | | |
| | | indium) | | | | | | | |
| Example 19 | Lithium | Metal lithium | Li₆PS₅Cl | Z1 | 0.7 | F1 | 0.7 | Silicone rubber | 623 |
| | cobalt oxide | | | | | | | | |
| Example 20 | Lithium | Metal lithium | Li₆PS₅Cl | Z2 | 0.7 | F2 | 0.7 | Butyl rubber | 615 |
| | cobalt oxide | | | | | | | | |
| Example 21 | Lithium | Metal lithium | Li₆PS₅Cl | Z3 | 0.7 | F3 | 0.7 | Polychloroprene | 609 |
| | cobalt oxide | | | | | | | | |
| Example 22 | Lithium | Metal lithium | Li₆PS₅Cl | Z4 | 0.7 | F4 | 0.6 | Epoxy resin | 602 |
| | cobalt oxide | | | | | | | | |
| Comparative | Lithium | Metal lithium | LLZTO | H1 | 0.6 | H1 | 0.8 | Polyurethane | 229 |
| Example 1 | cobalt oxide | | | | | | | | |
| Comparative | Lithium | Metal lithium | LLZTO | H2 | 0.6 | H2 | 0.8 | Polyurethane | 230 |
| Example 2 | cobalt oxide | | | | | | | | |
| Comparative | Lithium | Metal lithium | LLZTO | H3 | 0.6 | H3 | 0.8 | Polyurethane | 224 |
| Example 3 | cobalt oxide | | | | | | | | |
| Comparative | Lithium | Metal lithium | LLZTO | H4 | 0.6 | H4 | 0.8 | Polyurethane | 233 |
| Example 4 | cobalt oxide | | | | | | | | |
| Comparative | Lithium | Metal lithium | LLZTO | H5 | 0.6 | H5 | 0.8 | Polyurethane | 272 |
| Example 5 | cobalt oxide | | | | | | | | |
| Comparative | Lithium | Metal lithium | LLZTO | H6 | 0.6 | H6 | 0.8 | Polyurethane | 283 |
| Example 6 | cobalt oxide | | | | | | | | |
| Comparative | Lithium | Metal lithium | LLZTO | H7 | 0.6 | H7 | 0.8 | Polyurethane | 291 |
| Example 7 | cobalt oxide | | | | | | | | |
| Comparative | Lithium | Metal lithium | LLZTO | H8 | 0.6 | H8 | 0.8 | Polyurethane | 292 |
| Example 8 | cobalt oxide | | | | | | | | |
| Comparative | Lithium | Metal lithium | LLZTO | H9 | 0.6 | H9 | 0.8 | Polyurethane | 281 |
| Example 9 | cobalt oxide | | | | | | | | |
| Comparative | Lithium | Metal lithium | LLZTO | H10 | 0.6 | H10 | 0.8 | Polyurethane | 253 |
| Example | cobalt oxide | | | | | | | | |
| 10 | | | | | | | | | |
| Comparative | Lithium | Metal lithium | LLZTO | H11 | 0.6 | H11 | 0.8 | Polyurethane | 292 |
| Example | cobalt oxide | | | | | | | | |
| 11 | | | | | | | | | |
| Comparative | Lithium | Metal lithium | LLZTO | H12 | 0.6 | H12 | 0.8 | Polyurethane | 223 |
| Example | cobalt oxide | | | | | | | | |
| 12 | | | | | | | | | |
| Comparative | Lithium | Metal lithium | LLZTO | H13 | 0.6 | H13 | 0.8 | Polyurethane | 238 |
| Example | cobalt oxide | | | | | | | | |
| 13 | | | | | | | | | |
| Comparative | Lithium | Metal lithium | LLZTO | H14 | 0.6 | H14 | 0.8 | Polyurethane | 259 |
| Example | cobalt oxide | | | | | | | | |
| 14 | | | | | | | | | |
| Comparative | Lithium | Silicon | LLZTO | H15 | 0.6 | H15 | 1.1 | Polyurethane | 393 |
| Example | cobalt oxide | monoxide | | | | | | | |
| 15 | | | | | | | | | |
| Comparative | Lithium | Silicon- | LLZTO | H16 | 0.6 | H16 | 1.2 | Polyurethane | 377 |
| Example | cobalt oxide | carbon | | | | | | | |
| 16 | | composite | | | | | | | |
| | | material | | | | | | | |
| Comparative | Lithium | Graphite | LLZTO | H17 | 0.6 | H17 | 1.0 | Polyurethane | 459 |
| Example | cobalt oxide | | | | | | | | |
| 17 | | | | | | | | | |
| Comparative | Lithium | Lithium | LLZTO | H18 | 0.6 | H18 | 0.6 | Polyurethane | 321 |
| Example | cobalt oxide | indium alloy | | | | | | | |
| 18 | | (40 wt % | | | | | | | |
| | | indium) | | | | | | | |
| Comparative | Lithium | Metal lithium | Li₆PS₅Cl | H1 | 0.7 | H1 | 0.7 | Silicone rubber | 215 |
| Example | cobalt oxide | | | | | | | | |
| 19 | | | | | | | | | |
| Comparative | Lithium | Metal lithium | Li₆PS₅Cl | H2 | 0.7 | H2 | 0.7 | Butyl rubber | 202 |
| Example | cobalt oxide | | | | | | | | |
| 20 | | | | | | | | | |
| Comparative | Lithium | Metal lithium | Li₆PS₅Cl | H3 | 0.7 | H3 | 0.7 | Polychloroprene | 222 |
| Example | cobalt oxide | | | | | | | | |
| 21 | | | | | | | | | |
| Comparative | Lithium | Metal lithium | Li₆PS₅Cl | H4 | 0.7 | H4 | 0.6 | Epoxy resin | 199 |
| Example | cobalt oxide | | | | | | | | |
| 22 | | | | | | | | | |

TABLE 3
Conventional battery information and performance test

| | Positive | | | | | Normal |
|---|---|---|---|---|---|---|
| | electrode | Negative | | | Liquid retention | temperature |
| | active | electrode active | | Electrolyte | of electrolyte | cycle life |
| | material | material | Separator | solution | solution (g/Ah) | (cycles) |
| Comparative | Lithium | Metal lithium | PP | H1 | 1.4 | 220 |
| Example 23 | cobalt oxide | | | | | |
| Comparative | Lithium | Metal lithium | PP | H2 | 1.4 | 211 |
| Example 24 | cobalt oxide | | | | | |
| Comparative | Lithium | Silicon | PP | H15 | 1.7 | 374 |
| Example 25 | cobalt oxide | monoxide | | | | |
| Comparative | Lithium | Silicon-carbon | PP | H16 | 1.8 | 362 |
| Example 26 | cobalt oxide | composite | | | | |
| | | material | | | | |
| Comparative | Lithium | Graphite | PP | H17 | 1.6 | 443 |
| Example 27 | cobalt oxide | | | | | |
| Comparative | Lithium | Lithium indium | PP | H18 | 1.2 | 306 |
| Example 28 | cobalt oxide | alloy (40 wt % | | | | |
| | | indium) | | | | |

It may be learned from the cycle life test results of the batteries in the examples and the comparative examples in Table 2 that a battery cycle life can be significantly improved when electrolyte solutions with different compositions are respectively used at a positive electrode and a negative electrode in the battery in the present disclosure.

It may be learned from the cycle life test results of the conventional batteries in the examples in Table 2 and Table 3 that a cycle life of the battery in the present disclosure is significantly longer than that of the conventional lithium battery.

The foregoing descriptions of the disclosed embodiments cause a person skilled in the art to implement or use the present disclosure. Various modifications to these embodiments are apparent to a person skilled in the art. The general principles defined in this specification may be implemented in other embodiments without departing from the spirit or scope of the present disclosure. Therefore, the present disclosure is not limited to the embodiments shown in this specification, but is intended to conform to the widest scope consistent with principles and novel features disclosed in this specification.

What is claimed is:

1. An electrochemical apparatus, comprising a positive electrode plate, a negative electrode plate, a solid electrolyte membrane, a positive electrode electrolyte solution, a negative electrode electrolyte solution, and a packaging case;
wherein the positive electrode plate and the negative electrode plate are located on two sides of the solid electrolyte membrane, the positive electrode electrolyte solution is located on one side of the positive electrode plate, the negative electrode electrolyte solution is located on one side of the negative electrode plate, and the positive electrode electrolyte solution and the negative electrode electrolyte solution are separated by the solid electrolyte membrane.

2. The electrochemical apparatus according to claim 1, wherein a composition of the positive electrode electrolyte solution is different from a composition of the negative electrode electrolyte solution; and/or
the solid electrolyte membrane has a compact non-porous structure or a compact non-perforated structure.

3. The electrochemical apparatus according to claim 1, wherein the positive electrode electrolyte solution comprises a nitrile compound, and a mass fraction of the nitrile compound is not less than 5%; and/or
the negative electrode electrolyte solution comprises an ether compound, and a mass fraction of the ether compound is not less than 4%.

4. The electrochemical apparatus according to claim 3, wherein the mass fraction of the nitrile compound ranges from 5% to 80%; and/or
the mass fraction of the ether compound ranges from 4% to 80%.

5. The electrochemical apparatus according to claim 3, wherein the nitrile compound is selected from at least one of acetonitrile, propionitrile, butyronitrile, malononitrile, butanedinitrile, glutaronitrile, adiponitrile, 1,3,6-hexanetricarbonitrile, 1,3,5-pentanetricarbonitrile, ethylene glycol bis(propionitrile) ether, hexafluorocyclotriphosphazene, pentafluoro(ethoxy)cyclotriphosphazene, pentafluoro(phenoxy)cyclotriphosphazene, 1,4-dicyano-2-butene, 4-fluorobenzonitrile, p-tolunitrile, 2-fluorohexanedinitrile, 2,2-difluorobutanedinitrile, benzenetricarbonitrile, acrylonitrile, crotononitrile, fumaronitrile, or trans-hexenedinitrile; and/or
the ether compound is selected from at least one of ethylene glycol dimethyl ether, diethylene glycol dimethyl ether, triethylene glycol dimethyl ether, tetraethylene glycol dimethyl ether, propylene glycol dimethyl ether, dipropylene glycol dimethyl ether, tripropylene glycol dimethyl ether, 1,3-dioxolane, dioxane, tetrahydrofuran, 2-methyl tetrahydrofuran, 3-methyl tetrahydrofuran, 2-ethyl tetrahydrofuran, 3-ethyl tetrahydrofuran, or dimethyl tetrahydrofuran.

6. The electrochemical apparatus according to claim 5, wherein the nitrile compound is selected from at least one of acetonitrile or butanedinitrile; and/or
the ether compound is selected from at least one of ethylene glycol dimethyl ether, diethylene glycol dimethyl ether, propylene glycol dimethyl ether, dipropylene glycol dimethyl ether, 1,3-dioxolane, dioxane, or tetrahydrofuran.

7. The electrochemical apparatus according to claim 1, wherein the positive electrode electrolyte solution further comprises a lithium salt A, a solvent A, and an additive A, and the negative electrode electrolyte solution further comprises a lithium salt B, a solvent B, and an additive B; and
the lithium salt A and the lithium salt B are the same or different, and each are independently selected from one or more of lithium hexafluorophosphate, lithium tetrafluoroborate, lithium perchlorate, lithium hexafluorarsenate(V), lithium hexafluoroantimonate(V), lithium difluorophosphate, lithium 4,5-dicyano-2-trifluoromethylimidazole, lithium bis(oxalate) borate, lithium bis(malonato) borate, lithium difluorooxalate borate, lithium bis(difluoromalonato) borate, lithium (malonato oxalato) borate, lithium (difluoromalonato oxalato) borate, lithium tris(oxalato) phosphate, lithium tris(difluoromalonato) phosphate, lithium tetrafluoro(oxalato)phosphate, lithium bis(oxyalyl)difluorophosphate, lithium bis(fluorosulfonyl)imide, lithium bis(trifluoromethanesulphonyl)imide, lithium (fluorosulfonyl)(trifluoromethanesulfonyl)imide, lithium nitrate, lithium fluoride, LiN(SO₂CₙF₂ₙ₊₁)₂, or LiN(SO₂F)(SO₂CₘF_{2μm+1}), wherein n is an integer ranging from 2 to 10, and m is an integer ranging from 2 to 10; and/or
the solvent A and the solvent B are the same or different, and each are independently selected from one or more of ethylene carbonate, propylene carbonate, butylene carbonate, fluoroethylene carbonate, difluoroethylene carbonate, fluorodimethyl carbonate, fluoroethyl methyl carbonate, dimethyl carbonate, diethyl carbonate, dipropyl carbonate, ethyl methyl carbonate, methyl formate, ethyl formate, propyl formate, butyl formate, methyl acetate, ethyl acetate, propyl acetate, butyl acetate, methyl propionate, ethyl propionate, propyl propionate, butyl propanoate, methyl butyrate, ethyl butyrate, propyl butyrate, butyl butyrate, methyl difluoroacetate, ethyl difluoroacetate, γ-butyrolactone, γ-valerolactone, δ-valerolactone, fluoro-ether F-EPE, fluoro-ether D2, fluoro-ether HFPM, fluoro-ether MFE, fluoro-ether EME, sulfolane, dimethylsulfoxide, dichloromethane, or dichloroethane; and/or
the additive A and the additive B are the same or different, and each are independently selected from one or more of vinylene carbonate, vinyl ethylene carbonate, 1,3-propane sultone, trifluoromethyl ethylene carbonate, dimethyl sulfate, ethylene sulfate, methyl ethylene sulfate, propylene sulfate, ethylene sulphite, succinic anhydride, biphenyl, diphenyl ether, toluene, xylene, cyclohexylbenzene, fluorobenzene, p-fluorotoluene, p-fluoroanisole, tert-butylbenzene, tert-amylbenzene, propene sultone, butane sultone, methylene methanedisulfonate, glycol bis(propionitrile) ether, hexamethyldisilazane, heptamethyldisilazane, dimethyl methylphosphonate, diethyl ethylphosphonate, trimethyl phosphate, triethyl phosphate, triphenyl phosphate, triphenyl phosphite, tris(trimethylsilyl) borate, tris(trimethylsilyl) phosphate, 1,2-bis(cyanoethyloxy)ethane, 1,2,3-tri(cyanoethyloxy)propane, 3,3-sulfonyldipropionitrile, or 3-[(trimethylsilyl)oxy]propanenitrile.

8. The electrochemical apparatus according to claim 7, wherein the lithium salt A comprises at least 60 wt % lithium hexafluorophosphate; and/or
the lithium salt B comprises at least 50 wt % lithium difluorooxalate borate; and/or
the lithium salt B comprises at least 1 wt % lithium nitrate.

9. The electrochemical apparatus according to claim 1, wherein a ratio of a liquid retention m1 of the positive electrode electrolyte solution to a design capacity Q of the electrochemical apparatus satisfies 0.5 g/Ah≤m1/Q≤2 g/Ah; and/or
a ratio of a liquid retention m2 of the negative electrode electrolyte solution to the design capacity Q of the electrochemical apparatus satisfies 0.5 g/Ah≤m2/Q≤2 g/Ah.

10. The electrochemical apparatus according to claim 1, wherein the solid electrolyte membrane is an inorganic solid electrolyte membrane with a compact non-perforated structure;
and/or the solid electrolyte membrane is an inorganic solid electrolyte membrane with a compact non-porous structure; and/or
a density of the solid electrolyte membrane is greater than or equal to 99%; and/or
a liquid retention m1 of the positive electrode electrolyte solution is less than or equal to a liquid retention m2 of the negative electrode electrolyte solution.

11. The electrochemical apparatus according to claim 1, wherein a material forming the solid electrolyte membrane is at least one of a Garnet-type oxide electrolyte, a NASICON-type oxide electrolyte, a perovskite-type oxide electrolyte, or a sulfide electrolyte; and
the Garnet-type oxide electrolyte is selected from at least one of lithium lanthanum zirconium oxide, tantalum-doped lithium lanthanum zirconium oxide, or niobium-doped lithium lanthanum zirconium oxide; and/or
the NASICON-type oxide electrolyte is selected from at least one of lithium aluminum titanium phosphate, lithium aluminum germanium phosphate, lithium aluminum germanium titanium phosphate, or lithium zirconium silicon phosphate; and/or
the perovskite-type oxide electrolyte is lithium lanthanum titanium oxide; and/or
the sulfide electrolyte is selected from at least one of Li₃PS₄, Li₇P₃S₁₁, Li_{hd 4-X″}Ge_{1-x″} P_{x″}S₄, or Li₆PS₅X, wherein x″=0.4 or x″=0.6, and X is selected from at least one of F, Cl, Br, or I.

12. The electrochemical apparatus according to claim 1, wherein an ionic conductivity of the solid electrolyte membrane is greater than or equal to 0.1 ms/cm; and/or
a thickness of the solid electrolyte membrane ranges from 5 μm to 100 μm.

13. The electrochemical apparatus according to claim 12, wherein the ionic conductivity of the solid electrolyte membrane is greater than or equal to 1 ms/cm; and/or
the thickness of the solid electrolyte membrane ranges from 15 μm to 30 μm.

14. The electrochemical apparatus according to claim 1, wherein a positive electrode sealing ring is disposed between the positive electrode plate and the solid electrolyte membrane, and is configured to prevent the positive electrode electrolyte solution from leaking from an edge of the positive electrode plate; and/or
a negative electrode sealing ring is disposed between the negative electrode plate and the solid electrolyte membrane, and is configured to prevent the negative electrode electrolyte solution from leaking from the edge of the negative electrode plate.

15. The electrochemical apparatus according to claim 14, wherein a material forming the positive electrode sealing ring and a material forming the negative electrode sealing ring are the same or different, and each are independently selected from at least one of maleic anhydride grafted polypropylene, polyurethane, nitrile butadiene rubber, butyl rubber, polychloroprene, epoxy resin, or silicone rubber.

16. The electrochemical apparatus according to claim 15, wherein the positive electrode plate comprises a positive electrode current collector, a positive electrode coating region disposed on at least one side surface of the positive electrode current collector, and a positive electrode sealing region that is located on a periphery of the positive electrode coating region and connected to the positive electrode coating region; and a positive electrode coating paste is disposed in the positive electrode coating region, and the positive electrode sealing ring is disposed in the positive electrode sealing region; and/or
the negative electrode plate comprises a negative electrode current collector, a negative electrode coating region disposed on at least one side surface of the negative electrode current collector, and a negative electrode sealing region that is located on a periphery of the negative electrode coating region and connected to the negative electrode coating region; and a negative electrode coating paste is disposed in the negative electrode coating region, and the negative electrode sealing ring is disposed in the negative electrode sealing region.

17. The electrochemical apparatus according to claim 1, wherein the positive electrode plate further comprises a positive electrode active material, and the positive electrode active material comprises one or more of LiMₙ₂O₄, LiNiO₂, LiCoO₂, LiNi_{1-y1}Co_{y1}O₂, LiNiₐCo_{b}Al_{1-a-b}O₂, LiMn₁₋ₘ₄₋ₙ₂Niₘ₄Coₙ₂O₂, LiMPO₄, or Li₃V₂(PO₄)₃, wherein 0<y1<1, 0<a<1, 0<b<1, 0<a+b<1, 0<m4<1, 0<n2<1, 0<m4+n2<1, and M is one or more of Fe, Mn, or Co; and/or
the negative electrode plate further comprises a negative electrode active material, and the negative electrode active material comprises one or more of metal lithium, natural graphite, artificial graphite, mesocarbon microbeads, hard carbon, soft carbon, silicon, a silicon-carbon composite, SiO, Li—Sn alloy, Li—Sn—O alloy, Sn, SnO, SnO₂, spinel-structure lithium titanate, or Li—Al alloy.

18. The electrochemical apparatus according to claim 1, wherein the positive electrode plate further comprises a second binder, and the second binder comprises at least one of polyvinylidene fluoride, polytetrafluoroethylene, styrene-butadiene rubber, nitrile butadiene rubber, water-based acrylic resin, poly(vinyl alcohol), polyvinyl butyral, polyurethane, fluorinated rubber, carboxymethyl cellulose, or polyacrylic acid; and/or
the negative electrode plate further comprises a third binder, and the third binder comprises at least one of polyvinylidene fluoride, polytetrafluoroethylene, styrene-butadiene rubber, nitrile butadiene rubber, water-based acrylic resin, poly(vinyl alcohol), polyvinyl butyral, polyurethane, fluorinated rubber, carboxymethyl cellulose, polyacrylic acid, epoxy resin, hydroxypropyl cellulose, cellulose acetate, polyvinyl chloride, carboxylated polyvinyl chloride, polyvinylpyrrolidone, or nylon; and/or
the negative electrode plate further comprises a thickener, and the thickener comprises sodium carboxymethyl cellulose.

19. The electrochemical apparatus according to claim 1, wherein the positive electrode plate further comprises a conductive agent; and the negative electrode plate further comprises a conductive agent; and/or
the conductive agent of the positive electrode plate and the conductive agent of the negative electrode plate each independently comprise a carbon-based material, a metal-based material, a conductive polymer, or a mixture thereof, and the carbon-based material is selected from natural graphite, artificial graphite, carbon black, acetylene black, ketjen black, a carbon fiber, or any combination thereof, and/or
the metal-based material is selected from at least one of metal powder, a metal fiber, copper, nickel, aluminum, or silver; and/or
the conductive polymer is a polyphenylene derivative.

20. The electrochemical apparatus according to claim 1, wherein the electrochemical apparatus is a battery or a super capacitor.
